(19) United States
(12) Patent Application Publication
(10) Pub. No.: US 2006/0271569 A1
(43) Pub. Date: Nov. 30, 2006

(54) Method and system for determining shared context

(75) Inventors: Bryant Fong, Kirkland, WA (US); James Hilke, Redmond, WA (US); Shunri Guo, Sammamish, WA (US); Venkatesh Veeraraghavan, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corproation, Redmond, WA (US)

(21) Appl. No.: 11/139,402

(22) Filed: May 27, 2005

(51) Int. Cl. G06F 7/00

(52) U.S. Cl. 707/100

(57) ABSTRACT

The present invention facilitates determining a shared context between users of a computer system and dynamically generating a display of the shared context of one user from the perspective of the other user. The data from which a shared context between users may be determined includes data indicating that the users have something in common. Among other data, data indicating that the users have something in common may include data indicating a relationship, past or present, or direct or indirect, between the users. Alternatively, or in addition, data indicating that the users have something in common may include associations with the same individuals, communities, activities, or other special interests, whether those associations are past or present, and explicit or implicit.

### TECHNICAL FIELD

In general, the present invention relates to knowledge management and, more particularly, to determining a shared context among users in a computer system.

### BACKGROUND

Finding the right person for a particular purpose, such as finding a candidate for a job, or a consultant to work on a project, is often acknowledged as being one of most important tasks for a knowledge worker. However, it may not be sufficient to simply search for the person who has the pertinent skills or know-how. Unlike deciding to read a document or view a website, deciding whether to interact with a person usually involves more complex judgments. Other factors may determine whether the person is the right person, and whether the searcher will ultimately choose to interact with that person.

Existing knowledge management products focus on helping knowledge workers find persons having the pertinent skills or know-how. However, these products do not help knowledge workers to make complex judgments about whether to contact a particular person based on other factors that may or may not be related to their skills or know-how.

### SUMMARY

The foregoing problems with the prior state of the art are overcome by the principles of the present invention, which is directed toward methods, systems, computer program products, and data structures for determining a shared context between users of a computer system. The present invention is further directed toward methods, systems, computer program products, and data structures to facilitate the determination of the shared context, and to dynamically generate a display of one user from the perspective of the other user, based on the determined shared context.

According to one aspect of the invention, a shared context component generates a shared context display based on a first user who is the subject of the display, and a second user who is viewing the display. The shared context component obtains the identities of the first and second users, and further obtains data from which a shared context between the identified users may be determined.

According to another aspect of the invention, the data from which a shared context between the identified users may be determined includes data indicating that the users have something in common. Among other data, data indicating that the users have something in common may include data indicating a relationship, direct or indirect, between the users. Alternatively, or in addition, data indicating that the users have something in common may include current and/or past associations with the same individuals, communities, activities, and/or other special interests, whether those associations are explicit or implicit. Data indicating that the users have something in common is referred to as contextual information.

According to yet another aspect of the invention, the shared context component generates the shared context display. The shared context display may include, among other displays, a display of the contextual information, including the information indicating what the users have in common, such as the relationship between the users, and any individuals, communities, activities, or other special interests that the users have in common. In some cases, the shared context display may be generated for display in a portrait interface to information about a first user whose portrait is being displayed from the perspective of a second user to whom the portrait is displayed.

According to still another aspect of the invention, the shared context display for one or more users from the perspective of a viewer may be displayed in such a manner that those users with whom the viewer has more in common may be easily distinguished from those with whom the viewer has less in common.

In accordance with yet other aspects of the present invention, a computer-accessible medium for determining a shared context between users of a computer system is provided, including a medium for storing data structures and computer-executable components to facilitate the determination of the shared context between the users, and the generation of a shared context display of one user from the perspective of the other user, based on the determined shared context. The data structures define the shared context, the shared context display, and the contextual information comprising the shared context, including the information that represents or otherwise indicates what the users have in common, in a manner that is generally consistent with the above-described systems and methods. Likewise, the computer-executable components are capable of performing actions generally consistent with the above-described systems and methods.

### BRIEF DESCRIPTION OF THE DRAWINGS

The foregoing aspects and many of the attendant advantages of this invention will become more readily appreciated and understood by reference to the following detailed description taken in conjunction with the accompanying drawings, wherein:

FIG. 1 is a block diagram depicting one suitable operating environment in which a shared context between users of a computing system may be determined in accordance with the present invention;

FIG. 2 is a pictorial diagram illustrating a display of a shared context of one user from the perspective of another user in a portrait user interface in accordance with an embodiment of the present invention;

FIG. 3 is a block diagram illustrating in further detail certain aspects of the shared context component first illustrated in FIG. 1, and the displayed shared context illustrated in FIG. 2, in accordance with an embodiment of the present invention;

FIG. 4 is a block diagram of an example of a shared context display of the shared context of one user from the perspective of another user, formed in accordance with an embodiment of the present invention;

FIG. 5 is a flow diagram illustrating the logic for determining a shared context between users of a computing system as illustrated in FIGS. 1-3, performed in accordance with an embodiment of the present invention; and

FIGS. 6-8 are flow diagrams illustrating further aspects of the logic for determining a shared context between users of a computing system as illustrated in FIG. 5, performed in accordance with an embodiment of the present invention.

### DETAILED DESCRIPTION

When deciding whether to interact with a prospective job candidate, business contact or other individual, it would be helpful to understand the context within which the interaction with the person would take place. In particular, it would be helpful to know whether one has anything in common with the prospective job candidate, business contact or other individual, hereafter referred to as “shared context.”

For example, if Kate is looking for an expert in security in a certain product group, she can run a search that will return a number of individuals having the expertise she is seeking for that product group. Knowing whether she has anything in common with them makes the task of choosing the best person for the job much easier. For instance, when Kate reviews the available information on Aaron, she might see that she and Aaron are member of the same social interest group “Cascade Bicycle Club,” and have three people as shared colleagues. This information helps Kate to distinguish Aaron from Fred, with whom she has nothing in common.

In the following discussion, a computing system that is suitable for implementing a method to determine the shared context of users in a computing system, such as Kate, Aaron, and Fred, in accordance with embodiments of the present invention is described in detail. In general, shared context may include various contextual information associated with the users in a computing system, such as the organizational relationship between users, other users they both know, and communities to which they both belong. Examples of contextual information that comprises a shared context may include, among others, a common manager to which users report in an organization, common colleagues listed, for instance, in users' address books or other types of contact data, and common communities to which users belong.

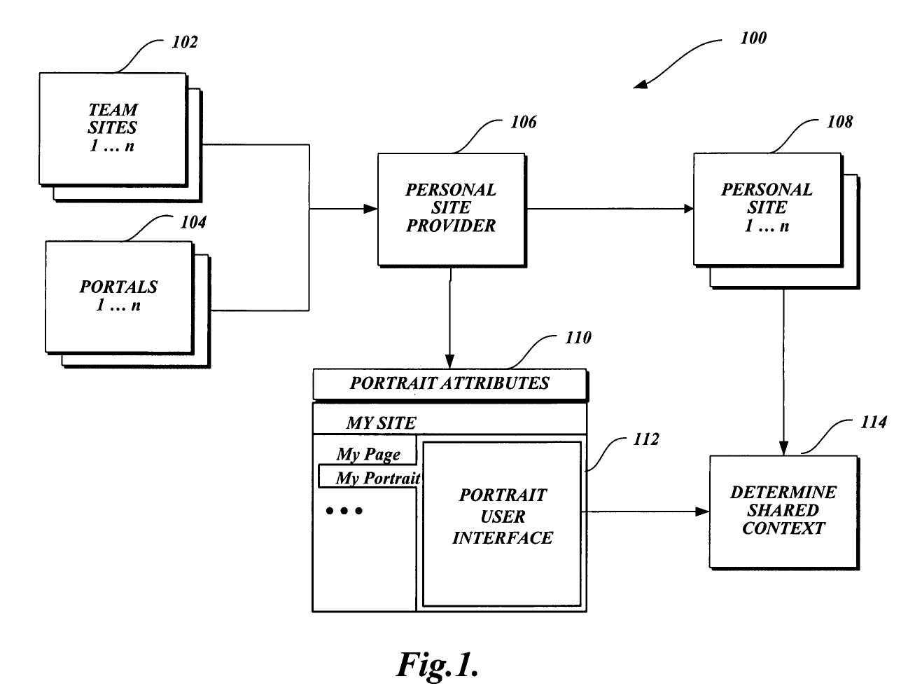

FIG. 1 is a block diagram depicting one suitable operating environment, in this case a personal site provider system 100, in which a shared context between users of a computing system may be determined in accordance with the present invention. As shown, the personal site provider system 100 may include a personal site provider 106 having access to a number of sites, such as team sites 1 . . . n 102 and/or portals . . . n 104 present in a computer system. The personal site provider 106 includes a generalized infrastructure for generating personal user websites 1 . . . n 108 that include user interfaces to information available from the various sites. In the illustrated embodiment, for example, the generalized infrastructure is implemented as portrait attributes 110 that define a template for a portrait user interface 112 used to display information from a personal user website on the computing system. In this particular operating environment, the portrait user interface 112 functions as a generalized public view of information from a personal user website for display to other users in the computing system, referred to in FIG. 1 as “My Portrait,” as opposed to the more private view of the personal user website that is displayed to the user himself, referred to in FIG. 1 as “My Page.” As such, it may be advantageous to be able to determine the shared context for display in the public view from the perspective of the viewer, as will be described below.

In a typical embodiment, a shared context component 114 is incorporated into a generalized infrastructure for generating a website, such as the portrait user interface 112 and portrait attributes 110, both parts of the infrastructure that comprises the personal site provider 106. Among other uses, the shared context component 114 may be used as part of generating the public view of a user from the perspective of the viewer, typically another user in the system 100.

In general, the shared context component 114 includes the logic used to determine the contextual information that comprises the shared context between one user and another user, such as between a knowledge worker and a job candidate or prospective business associate whose personal user website is being viewed by the knowledge worker. In one embodiment, the shared context component 114 may be implemented as a web part in the generalized infrastructure, where the web part includes the logic to determine the shared context between two users and/or the logic to display that shared context in the portrait user interface 112.

It is to be understood that the shared context component 114 may be incorporated into systems other than the personal site provider system 100 illustrated in FIG. 1 without departing from the scope of the claims that follow. As an example, the shared context component 114 may be advantageously employed in a social networking website. For instance, a matchmaking site could incorporate the shared context component 114 into their users' profile pages to break the ice and encourage potential suitors to contact those users with which they have something in common. In another case, a recruiting site could incorporate a shared context component 114 into the display of resumes in order to further differentiate candidates. In each case, the shared context component 114 may be advantageously used to bridge a more personal connection to an individual that might not otherwise be available

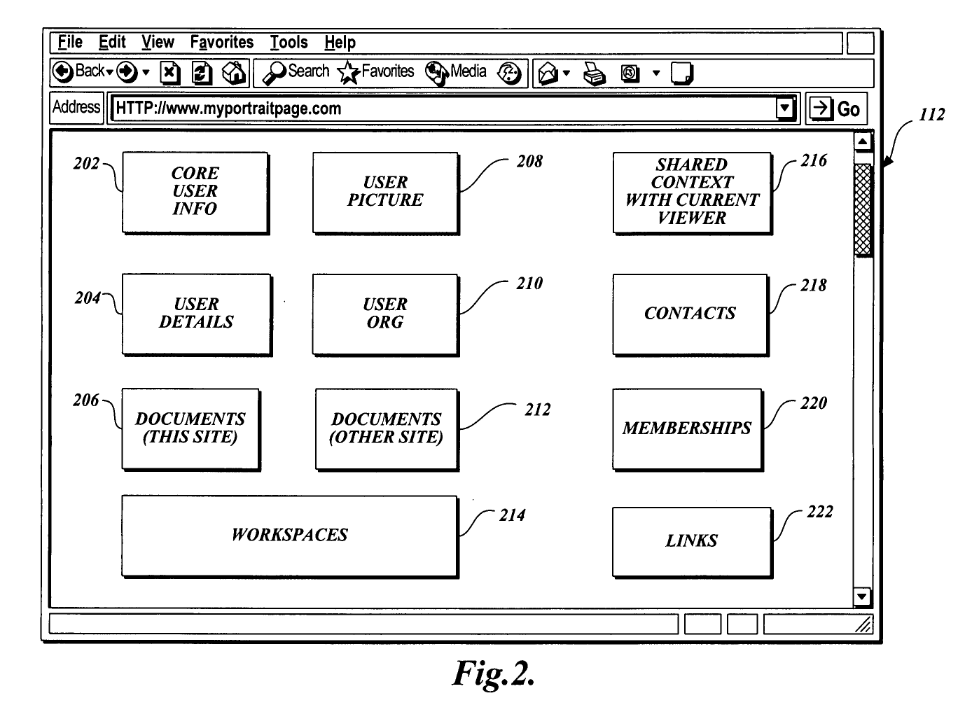

FIG. 2 is a pictorial diagram illustrating a display of a shared context of one user from the perspective of another user in a portrait user interface, such as the portrait user interface 112 described in FIG. 1, in accordance with an embodiment of the present invention. In FIG. 2, a web page representing a portrait of a user in a computing system, such as the example web page in FIG. 2 named “HTTP://www.myportraitpage.com, ” is displayed in browser window 200. The web page typically includes various sections that contain information related to the user whose portrait is being displayed, including a section for core user info 202, user details 204, the user's picture or other representation of the user 208, the organization with which the user is associated 210, documents on this site that are related to the user 206, as well as documents on other sites that are related to the user 212, and workspaces associated with the user 214.

The web page displayed in browser window 200 may also include a section in the portrait for displaying the shared context 216, i.e., what the user has in common with the current viewer, in accordance with an embodiment of the invention. The web page displayed in browser window 200 may also include a section in the portrait for displaying other information, such as the user's contacts 218, memberships 220, and links 222. Because the contextual information that comprises the shared context 216 will change depending on the identity of the current viewer who is viewing the user's portrait, displaying the shared context is performed dynamically in conjunction with the shared context component 114. Displaying the shared context is also typically performed dynamically in conjunction with the shared context component 114 in order to determine and display the most up-to-date contextual information comprising the shared context 216 that is currently available.

It should be understood that the arrangement and display of the shared context 216 in the web page illustrated in FIG. 2 is by way of example only. Other displays and uses of shared context 216, such as displays in interfaces other than portrait interfaces, or uses in systems other than personal site provider systems, may be employed without departing from the scope of the claims that follow. For example, it may be advantageous to a viewer, such as a knowledge worker, to simultaneously display the shared context 216 of a number of users, e.g., several potential job candidates or prospective business associates, on a single web page rather than to view each shared context individually as part of each user's portrait web page. In that case, displaying the shared context may be performed iteratively in conjunction with the shared context component 114 to determine the the contextual information that comprises the shared context 216 for each of the users in which the viewer/knowledge worker is interested. The resulting shared contexts 216 for each of the users may be displayed together in one or more web pages for ease of access by the viewer/knowledge worker.

In one embodiment, the resulting shared contexts 216 might also be ranked, or otherwise organized in a manner that is meaningful to the viewer/knowledge worker. For example, the shared contexts 216 of those users with whom the viewer/knowledge worker has more in common may be displayed above those with whom he or she has less in common, or may be highlighted, labeled, or otherwise visibly distinguished from those with whom the viewer/knowledge worker has less in common.

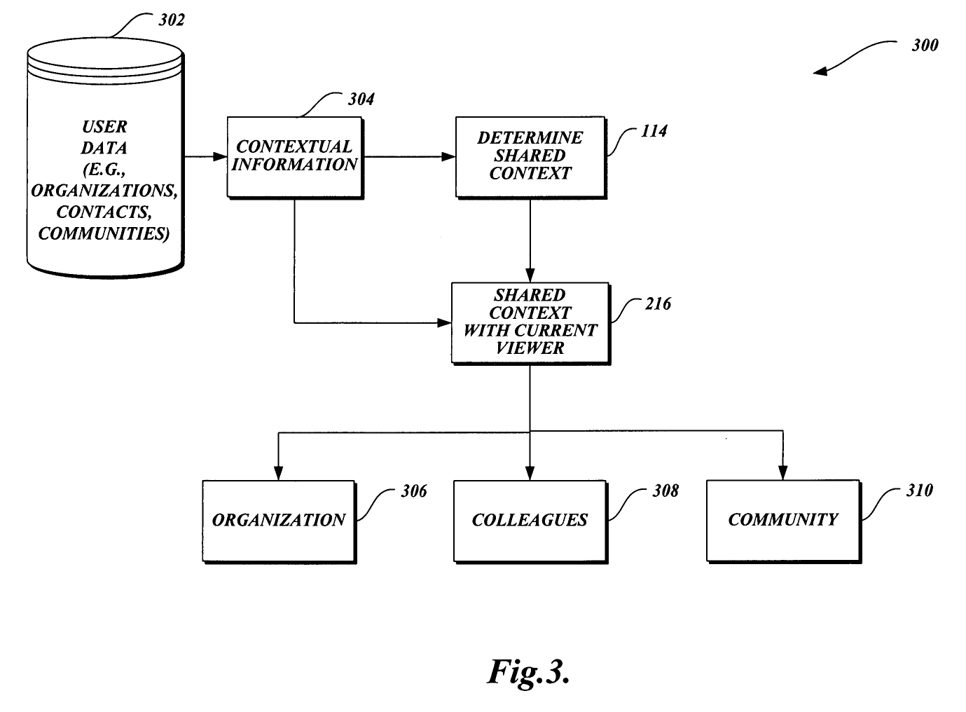

FIG. 3 is a block diagram illustrating in further detail certain aspects of the shared context component 114 and the displayed shared context 216 illustrated in FIGS. 1 and 2, in accordance with an embodiment of the present invention. As shown in the illustrated embodiment, a shared context system 300 typically includes the shared context component 114 which may be used to determine the shared context between users, as well as to generate the shared context display 216 of one user from the perspective of another. Among other functions, the shared context component 114 obtains the identities of the users, uses those identities to obtain contextual information 304 from user data 302, determines from the obtained contextual information whether the users have anything in common, and generates the shared context display 216.

In a typical embodiment, the user data 302 may include user profile data comprising properties or attributes that represent or otherwise indicate something about a user, such as the user's occupation, skills, responsibilities, interests, contacts, correspondents, etc. The user profile data may generally include any data from which a shared context between users may be derived, including data that indicates what a user may have in common with another user, now or in the past, or where a user fits within an organizational hierarchy.

In some cases, the data may be susceptible to exact or generic pattern matching. In other cases, data that does not necessarily match on a character by character basis may still be compared using an algorithm or other type of analysis to determine whether there is some correlationship between the data that indicates there is something in common between users based on the data values and the type of data. For example, user profile data may indicate that a first user has expertise in C++, while a second user has expertise in C#, and a third user has expertise in Carpentry. Although all three values match on the character “C,” by applying a closeness algorithm it is apparent that C++ and C# are closer than C+ and Carpentry. Thus, the first and second user may be determined to have expertise in common, whereas the first and third user do not. As another example, 5-digit zip code data for the first user may not necessarily match the second and third users' zip code data. But, the values might still be compared to determine whether the first user lives closer to the second or third user. In other words, while a character by character comparison of data may indicate that users have nothing in common, the application of a closeness algorithm or other type of analysis may be used to determine that the users do have something in common, or at least have more in common than other users.

In a typical embodiment, the shared context display 216 comprises the contextual information 304 which the shared context component 114 determined indicates that one user and another user have, or in some cases do not have, something in common. The contextual information 304 may include such information as the users' relationship, either direct or indirect, vis a vis the organization 306 of which the users are a part, shared contacts 308, i.e., whether both users have an association, explicit or implicit, with the same individuals, and shared community 310, i.e., whether there are any communities, activities, or other special interests with which both users have an association, whether explicit or implicit, outside of the organization 306. An example of contextual information indicating a users' relationship vis a vis the organization 306 may include, among others, the name of a common manager to whom both users report. An example of contextual information indicating a users' shared contacts 308 may include, among others, the names of individuals present in both users' address books, or correspondents to whom both users have sent emails or instant messages. An example of contextual information indicating shared community 310 may include, among others, the names of communities or other entities to which both users belong, such as discussion lists and collaborative team sites or workspaces in which both users participate. Other examples of contextual information indicating shared community 310 include information that indicates any activities or other special interests with which both users are associated.

It should be understood that the examples of contextual information illustrated in FIG. 3 are by way of example only, and that other types of contextual information 304 may be used in the determination and display of shared context 216 without departing from the scope of the claims that follow.

In one embodiment, the shared context display 216 may comprise contextual information that indicates the lack of a shared context, either because the shared context component 114 determines that the users do not have anything in common, i.e., the absence of a shared context, or in some cases, because the shared context component determines that the contextual information indicates that they have an oppositional context. For example, shared context component 114 may determine that the users are members of political parties representing opposing points of view. From the knowledge worker's/viewer's perspective, the absence of a shared context and/or an oppositional context may, in some cases, be as helpful as the presence of a shared context.

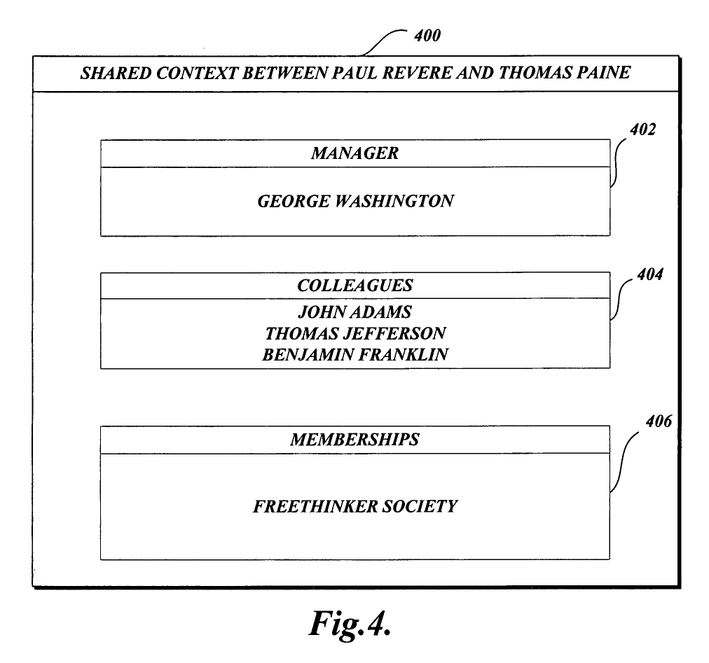

FIG. 4 is a block diagram of an example of a shared context display of the shared context of one user from the perspective of another user, formed in accordance with an embodiment of the present invention. In the illustrated example, a shared context display 400 representing a shared context between two users, Paul Revere and Thomas Paine, includes a manager 402 that both have in common, listed as George Washington, a set of contacts 404 that both have in common, listed as John Adams, Thomas Jefferson, and Benjamin Franklin, and a membership 406 that both have in common, listed as the Freethinker's Society. Since the contextual information comprising the shared context display 400 would be the same, whether displayed from the perspective of either user, Paul Revere or Thomas Paine, the display 400 may be used, for example, in the portrait user interface 112, illustrated in FIGS. 1 and 2, to present the shared context of either user from the other user's perspective.

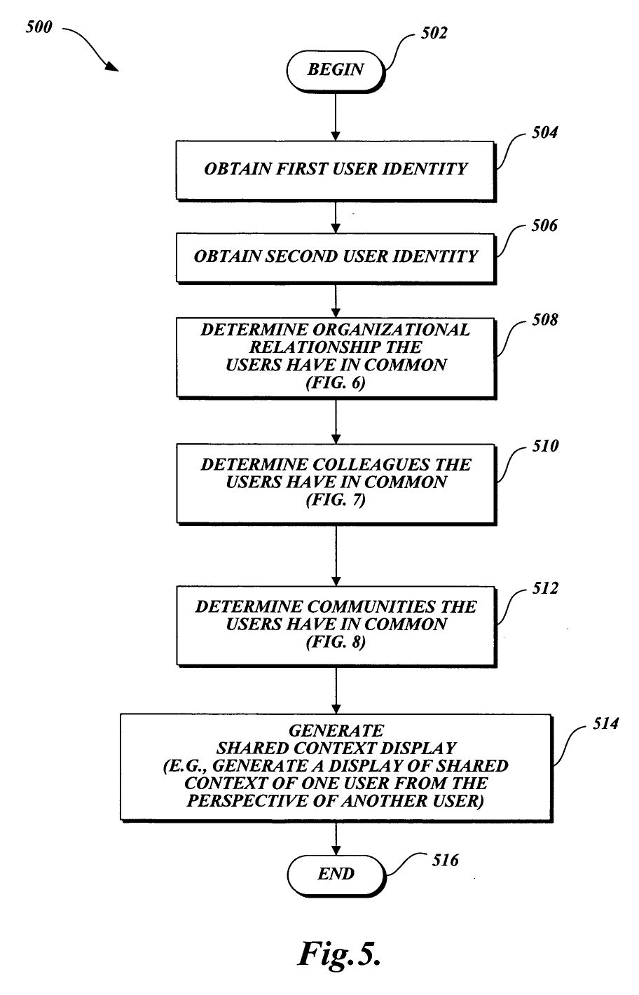

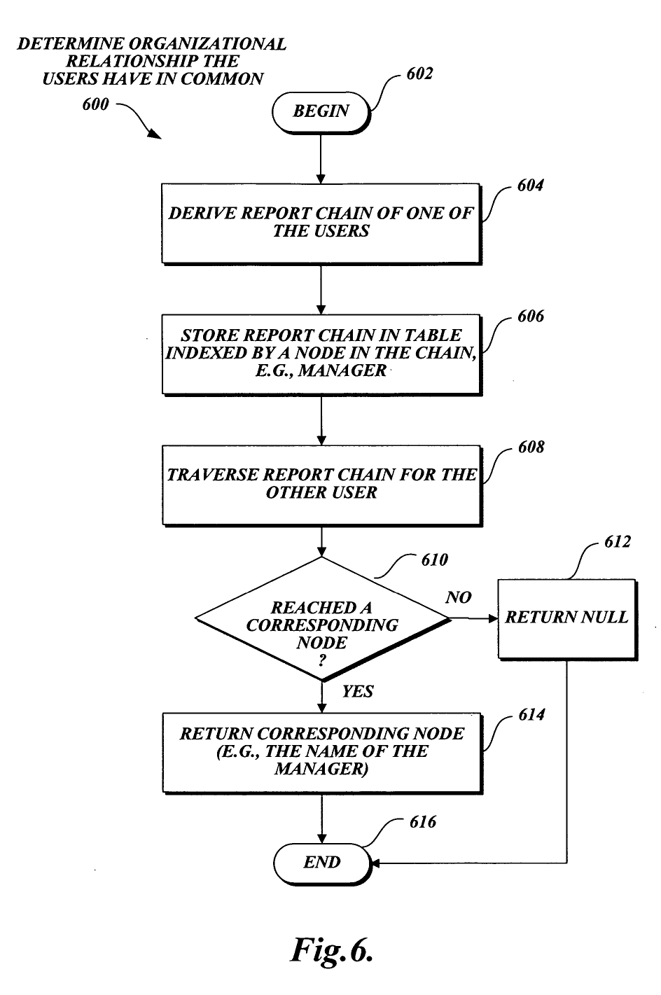

FIG. 5 is a flow diagram that illustrates certain aspects of a method 500 for determining a shared context between users of a computing system as illustrated in FIGS. 1-3, the method being performed in accordance with an embodiment of the present invention. In the description that follows, numerous references will be made to FIGS. 6-8, which represent flow diagrams that further illustrate certain aspects of determining a shared context between users of a computing system in accordance with an embodiment of the present invention.

With reference to FIG. 5, and beginning at process oval 502, the method 500 begins with processes 504 and 506 to obtain the identities of two users of a computing system for whom a shared context is to be determined, referred to here as a first user and a second user. The method 500 uses the obtained identities to determine the shared context between the users, if any. In a typical embodiment, one of the users is a viewer of information about the other user, such as information that is presented to the viewer as a web portrait of the other user. The shared context between the users, if any, is typically displayed to the viewer from the viewer's perspective as part of the web portrait.

In one embodiment, determining the shared context between the users includes a process 508 to determine an organizational relationship between the identified users. As previously noted, in a typical embodiment, the organizational relationship may be represented by contextual information that indicates which manager that the users have in common, if any. An example of determining the organizational relationship between the users is described in further detail with reference to FIG. 6, below.

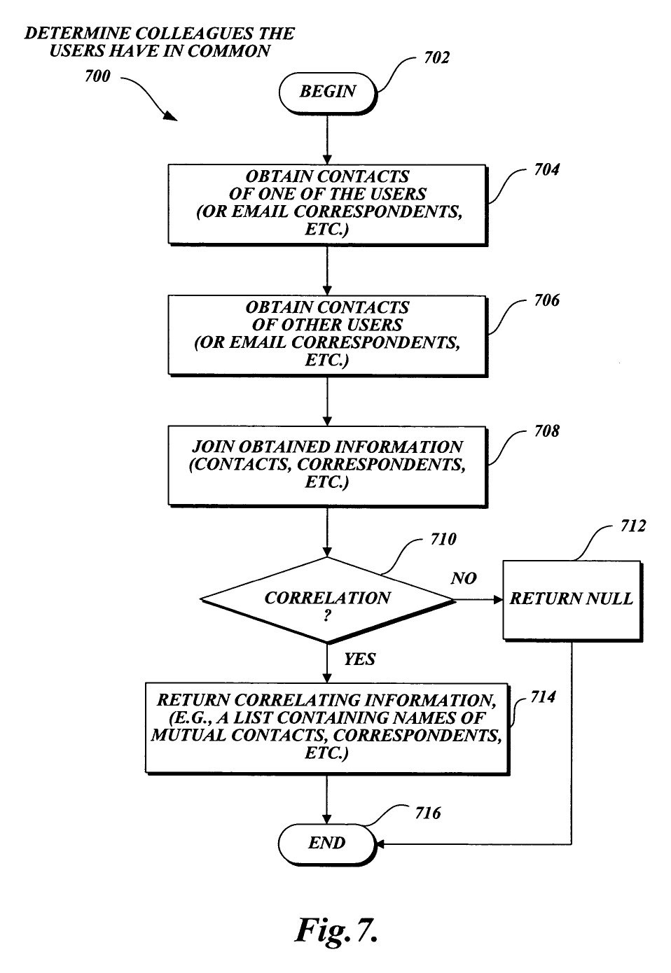

In one embodiment, determining the shared context between the users includes a process 510 to determine whether the users have any colleagues in common. In a typical embodiment, the determination whether the users have any colleagues in common is based on whether the users have associations, explicit or implicit, with the same individuals, such as contacts listed in the users' address books, or correspondents with whom the users have exchanged emails or instant messages. An example of determining whether the users have any colleagues in common is described in further detail with reference to FIG. 7, below.

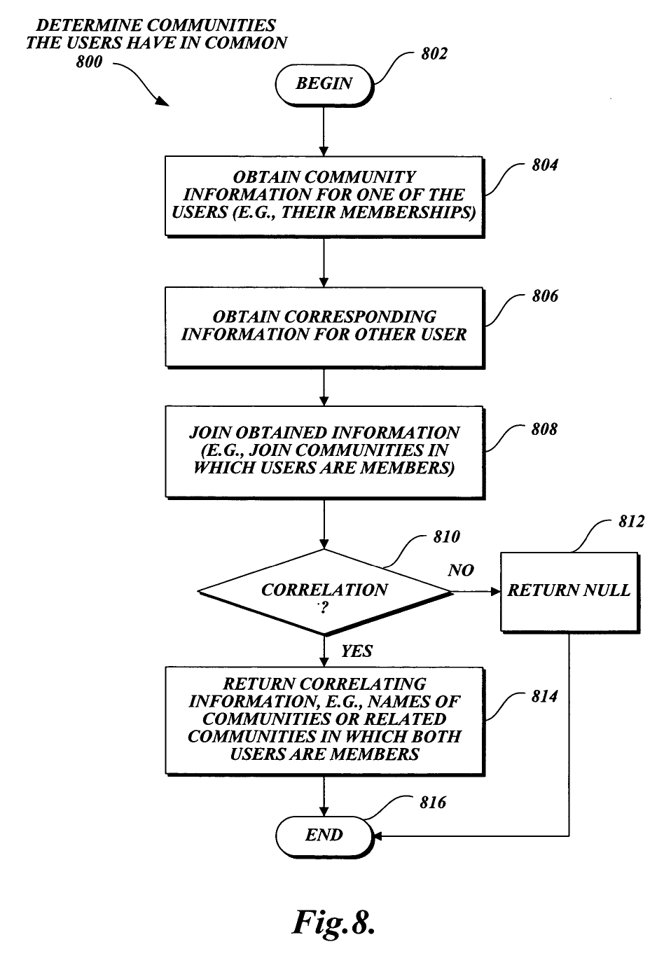

In one embodiment, determining the shared context between the users includes yet another process 512 to determine whether the users have any communities in common. In a typical embodiment, the determination whether the users have any communities in common is based on whether the users are associated, explicitly or implicitly, with the same communities, such as the same sports or hobby clubs, or other types of activities or other special interest groups. An explicit association may be determined through membership or other type of affiliation, and an implicit association may be determined through certain types of user behavior that can be tracked, such as a visit to a website. An example of determining whether the users have any communities, activities, or other special interest in common is described in further detail with reference to FIG. 8, below.

Once the shared context between the users has been determined, by any one or a combination of the processes 508, 510, 512, the method 500 may, in some cases, continue at process block 514 to generate a shared context display based on the contextual information comprising the determined shared context, if any. The shared context display will typically comprise a display of contextual information about one user from the other user's perspective. For example, the method may generate a shared context display that is displayed in conjunction with the portrait user interface 112 previously described with reference to FIGS. 1 and 2. The method 500 concludes processing at process oval 516.

FIG. 6 is a flow diagram that further illustrates certain aspects of a method 600 for determining a shared context between users of a computing system as illustrated in FIGS. 1-3, in particular those aspects related to determining whether the identified users have any relationship to each other. For example, users may be said to have an organizational relationship when they both report to the same manager. Of course, it is understood that users may have other types of relationships that may be determined in accordance with an embodiment of the invention without departing from the scope of the claims that follow.

Using the organizational relationship example, the method 600 begins at process oval 602 with a process 604 to derive a report chain for one of the users that were identified in FIG. 5. The report chain is typically an association between the user and another individual in the organization to whom the user reports, either directly or indirectly, such as a project manager, supervisor, mentor, administrative manager, etc. For example, the derived report chain for a user may be in the format of “User→Manager,” where “User” represents the individual that is lower in the organizational hierarchy, and “Manager” represents the individual that is higher in the organizational hierarchy. For example, the derived report chain may include such reports as User→CoryH, User→WrMore, and User→BillG, which respectively represent the project manager (CoryH) and manager (WrMore) to whom the user reports and, ultimately, the head of the organizational hierarchy, such as the president or chairman of the organization (BillG) to whom everyone in the organization reports.

In a typical embodiment, the method 600 continues at process block 606 to store the derived report chain in a table that is indexed by a node in the chain, e.g., in a table that is indexed by the manager to whom the user reports. At process block 608, the method 600 similarly derives, stores, or otherwise traverses the report chain of the other user with whom the organizational relationship is to be determined. At comparison block 610, the method 600 determines whether there is a corresponding node in the respective report chains for each of the two users, e.g., whether the two users report to the same manager or project manager. In a typical embodiment, the node in the report chain that is at the lowest level in the organizational hierarchy, i.e., the most direct report, is usually of most interest for the purpose of determining shared context since, in most organizations, everyone will ultimately report to the node that is at the highest level.

The method 600 continues at process block 612 to return a null set when there is no corresponding node, and at process block 614 when there is a corresponding node. In a typical embodiment, when there is a corresponding node, at process block 614 the method 600 returns the value of the corresponding node, such as the name of the manager that the corresponding node represents. The returned information becomes part of the contextual information on which the display of the shared context is based. The method concludes at termination oval 616.

FIG. 7 is a flow diagram that further illustrates certain aspects of a method 700 for determining a shared context between users of a computing system as illustrated in FIGS. 1-3, in particular those aspects related to determining whether the identified users have any colleagues in common. For example, users may be said to have colleagues or other individuals in common when they both have some association with the same individual, whether that association is a current or past association, or is an explicit or implicit association. For example, it may be that the users have the same individual listed in their electronic address book or their instant message buddy list, an explicit association, and/or may have corresponded with the same individual, as evidenced by their past or recent emails or instant messages, an implicit association. In such an example, the method 700 determines whether the users have any colleagues in common by determining whether the users have any one or a combination of such associations, i.e., address book entries and/or correspondence addressed from or to the same individual. Of course, it is understood that users may have other types of associations with colleagues or other individuals that may be determined in accordance with an embodiment of the invention, and without departing from the scope of the claims that follow.

Using the address book and correspondence associations as an example, the method 700 begins at process oval 702 with process block 704 to obtain contextual information representing contacts and/or correspondents for one of the users that were identified in FIG. 5. The method 700 continues at process block 706 to obtain corresponding contextual information, i.e., contacts and/or correspondents, for the other user identified in FIG. 5.

In one embodiment, the method 700 continues at process block 708 to join the obtained contextual information for the both users, and at decision block 710 to determine whether there is any correlation between the joined contextual information. For example, the method 700 determines whether any of the contacts and/or correspondents obtained for one user represents the same individual that is represented in the contacts and/or correspondents obtained for the other user, i.e., whether the users have mutual contacts and/or correspondents. In a typical embodiment, this type of contextual information, i.e., contacts and/or correspondents, is stored in a separate database for quick lookup. This avoids having to access the user's address book in order to compare results. If there is no correlation, then the method 700 returns a null value 712 to the calling method 500 for determining a shared context. Otherwise, if there is a correlation, the method 700 continues at process block 714 to return the contextual information. For example, the method 700 may return a list containing the names of the mutual contacts and/or correspondents. In a typical embodiment, the returned information becomes part of the contextual information on which the display of the shared context is based. The method concludes at termination oval 716.

FIG. 8 is a flow diagram that further illustrates certain aspects of a method 800 for determining a shared context between users of a computing system as illustrated in FIGS. 1-3, in particular those aspects related to determining whether the identified users have any community in common. For example, users may be said to have a community in common when they both have some association with the same community, neighborhood or other geographic area, activity, or other special interest, whether that association is past or present, or explicit or implicit. For example, it may be that the users have an association with bicycling, as evidenced by their memberships in one or more bicycling clubs, an explicit association, or participation in bicycling activities, an implicit association. As another example, it may be that the users have an association with the sports community in general, as evidenced by their participation in various other sports activities, such as the aforementioned bicycling, running, weight-lifting, etc. In still another example, it may be that the users reside in the same neighborhood or other geographic area as determined by comparing their address and zip code data.

Using the illustrated examples, the method 800 determines whether the users have any community, neighborhood, activity or other special interest in common by determining whether the users have any one or a combination of such associations, e.g., memberships in the same or similar bicycling clubs, residents in the same neighborhood or other geographic area, participants in an activity or other special interest including recent visits to websites sponsored by a same or related special interest group, or otherwise having to do with the same or related special interest. Of course, it is understood that users may have other types of associations with communities, activities, or other special interests that may be determined in accordance with an embodiment of the invention, and without departing from the scope of the claims that follow.

Using the membership and participant association as an example, the method 800 begins at process oval 802 with process block 804 to obtain contextual information representing memberships in clubs and/or participation in various activities for one of the users that were identified in FIG. 5. The method 800 continues at process block 806 to obtain corresponding contextual information, i.e., memberships and/or participation, for the other user identified in FIG. 5.

In one embodiment, the method 800 continues at process block 808 to join the obtained contextual information for the both users, and at decision block 810 to determine whether there is any correlation between the joined contextual information, e.g., whether any of the membership, residence or participation, information obtained for one user represents membership, residence, or participation in the same, substantially similar, or related community, neighborhood, activity, or other special interest that is represented in the memberships, residence or participation information obtained for the other user. If there is no correlation, then the method 800 returns a null value 812 to the calling method 500 for determining a shared context. Otherwise, if there is a correlation, the method 800 continues at process block 814 to return the contextual information. For example, the method 800 may return a list containing the names of the communities, neighborhood, activities, and/or special interests that both users have in common. In a typical embodiment, the returned information becomes part of the contextual information on which the display of the shared context is based. The method concludes at termination oval 816.

The foregoing discussion has been intended to provide a brief, general description of a computing system suitable for implementing various features of the invention. Although described in the general context of a personal computer usable in a distributed computing environment, in which complementary tasks may be performed by remote computing devices linked together through a communication network, those skilled in the art will appreciate that the invention may be practiced with many other computer system configurations. For example, the invention may be practiced with a personal computer operating in a standalone environment, or with multiprocessor systems, minicomputers, mainframe computers, and the like. In addition, those skilled in the art will recognize that the invention may be practiced on other kinds of computing devices including laptop computers, tablet computers, personal digital assistants (PDAs), cellphones, game consoles, personal media devices, or any device upon which computer software or other digital content is installed.

For the sake of convenience, some of the description of the computing system suitable for implementing various features of the invention included references to the Windows operating system, and references to the Windows Server, Office, Internet Information Server, and SharePoint Services products. However, those skilled in the art will recognize that those references are only illustrative and do not serve to limit the general application of the invention. For example, the invention may be practiced in the context of other operating systems such as the LINUX or UNIX operating systems, and other general purpose server software.

Certain aspects of the invention have been described in terms of programs executed or accessed by an operating system in conjunction with a personal computer. However, those skilled in the art will recognize that those aspects also may be implemented in combination with various other types of program modules or data structures. Generally, program modules and data structures include routines, subroutines, programs, subprograms, methods, interfaces, processes, procedures, functions, components, schema, etc., that perform particular tasks or implement particular abstract data types.

The embodiments of the invention in which an exclusive property or privilege is claimed are defined as follows:

1. A method for determining a shared context between users of a computing system, the method comprising:
obtaining contextual information for a first and second user of a computing system; and
comparing the contextual information for the first user with the contextual information for the second user to determine a shared context, the shared context representing contextual information that the first and second user have in common.

2. The method of claim 1, wherein the shared context indicates that the first and second user have in common a common relationship.

3. The method of claim 2, wherein the common relationship is reporting to a same person in an organization.

4. The method of claim 3, wherein reporting to the same person in the organization includes reporting to the same manager.

5. The method of claim 3, further comprising:
deriving a report chain for each of the first and second user; and
traversing the report chain for the first user until reaching a node that corresponds to a node in the report chain for the second user, wherein the corresponding nodes represent the common relationship.

6. The method of claim 1, wherein the shared context indicates that the first and second user have in common a common association.

7. The method of claim 6, wherein the common association is an association with at least one of a same individual, a same community, a same geographic area, a same activity, and a same special interest.

8. The method of claim 1, further comprising displaying the shared context to the first user, including displaying contextual information for the second user from a perspective of the first user.

9. The method of claim 1, further comprising:
obtaining contextual information for a third user of the computing system;
comparing the contextual information for the first user with the contextual information for the third user to determine additional shared context, the additional shared context representing contextual information that the first and third user have in common; and
displaying the shared context and additional shared context to the first user, including displaying contextual information for the third user from the perspective of the first user wherein displaying distinguishes users having more in common from users having less in common.

10. The method of claim 9, wherein displaying shared contexts includes displaying shared contexts in a portrait interface for presenting information about users.

11. A system for finding users having things in common, the system comprising:
user data having contextual information for users;
a processor having access to the user data, the processor to determine a shared context between the users from the contextual information; and
a display device in communication with the processor, the processor to display the shared context on the display device from a perspective of one of the users.

12. The system of claim 11, further comprising:
a portrait interface for displaying information about users, wherein the processor is to display the shared context between the users in the portrait interface for displaying information about at least one of the users.

13. The system of claim 11, wherein the user data having contextual information for users includes user profile data representing at least one of a relationship within an organization and an association with a colleague, community, geographic area, or special interest.

14. The system of claim 13, wherein the processor is to determine the shared context between the users from the user profile data, the shared context indicating the relationship that the users have in common.

15. The system of claim 13, wherein the processor is to determine the shared context between the users from the user profile data, the shared context indicating the association that the users have in common.

16. A computer-accessible medium having instructions for determining shared context between users of a computer system, the instructions comprising:
obtain contextual information for a first and second user of a computing system; and
derive a shared context from the contextual information, the shared context representing contextual information that the first and second user have in common; and
display the shared context to the first user, including displaying contextual information for the second user from a perspective of the first user.

17. The computer-accessible medium of claim 16, wherein the instruction to derive a shared context from the contextual information includes instructions to correlate the contextual information for the first user with the contextual information for the second user, and to save the correlating contextual information in the shared context.

18. The computer-accessible medium of claim 16, wherein the shared context indicates that the first and second user have in common a common relationship, the common relationship including reporting to a same person in an organization.

19. The computer-accessible medium of claim 16, wherein the shared context indicates that the first and second user have in common a common association, the common association including an association with at least one of a same individual, a same community, a same geographical area, a same activity, and a same special interest.

20. The computer-accessible medium of claim 16, the instructions further comprising instructions to:
obtain contextual information for a third user of the computing system;
derive additional shared context representing contextual information that the first and third user have in common; and
display the shared context and additional shared context to the first user, including displaying contextual information for the third user from the perspective of the first user to highlight which of the second and third users has more in common with the first user.
